(19) United States
(12) Patent Application Publication
(10) Pub. No.: US 2021/0281313 A1
(43) Pub. Date: Sep. 9, 2021

(54) COMMUNICATION DEVICE, COMMUNICATION METHOD, AND ELECTRONIC APPARATUS

(71) Applicant: SONY SEMICONDUCTOR SOLUTIONS CORPORATION, KANAGAWA (JP)

(72) Inventors: TAKAHIRO TAKEDA, KANAGAWA (JP); YASUHIRO OKADA, KANAGAWA (JP)

(21) Appl. No.: 16/330,531

(22) PCT Filed: Sep. 14, 2017
(86) PCT No.: PCT/JP2017/033205

§ 371 Date: Mar. 5, 2019

(30) Foreign Application Priority Data
Sep. 27, 2016 (JP) 2016-188259

(51) Int. Cl. H04B 7/10; H01Q 21/24; H04B 1/44; H04B 15/00; H01P 1/16

(52) U.S. Cl. CPC H04B 7/10; H01Q 21/245; H01P 1/16; H04B 15/00; H04B 1/44

(57) ABSTRACT

The present technology relates to a communication device, a communication method, and an electronic apparatus enabling a signal to be transmitted regardless of a polarization direction of a communication device which is a communication partner so that interference in a signal can be suppressed. A communication device includes: a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and a transmission control unit that sets the direction of the first polarized wave and the direction of the second polarized wave in accordance with the other communication device. The present technology can be applied to, for example, a communication device transmitting a millimeter wave signal.

### TECHNICAL FIELD

The present technology relates to a communication device, a communication method, and an electronic apparatus, and particularly, to a communication device, a communication method, and an electronic apparatus transmitting a signal using a polarized wave.

### BACKGROUND ART

There are communication systems that perform communication between two communication devices in a state in which casings (device bodies) are in contact or in proximity. As an example of such a kind of communication system, a communication system in which one of two communication devices is configured as a mobile terminal device and the other communication device is configured as a wireless communication device called a cradle can be exemplified (for example, see Patent Document 1).

In a case where bidirectional transmission is performed in the foregoing communication system, there is concern of interference between transmitted signals occurring. As a countermeasure, for example, transmission of signals in both directions using polarized waves of which directions are mutually different is assumed to be performed.

### CITATION LIST

### Patent Document

Patent Document 1: Japanese Patent Application Laid-Open No. 2006-65700

### SUMMARY OF THE INVENTION

### Problems to be Solved by the Invention

However, in a case where signals in both directions using polarized waves of which directions are mutually different are transmitted, transmission of signals may not be performed unless the directions of the polarized waves between communication devices match each other.

The present technology is devised in view of such a circumstance and enables a signal to be transmitted regardless of a polarization direction of a communication device which is a communication partner so that interference in a signal can be suppressed.

### Solutions to Problems

A communication device of a first aspect of the present technology includes: a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and a transmission control unit that sets the direction of the first polarized wave and the direction of the second polarized wave in accordance with the other communication device.

The communication unit may include a first waveguide that performs the transmission of the first signal and a second waveguide that performs the transmission of the second signal.

The communication unit may include a sending unit, a reception unit, a first path connecting the sending unit to the first waveguide and exciting a polarized wave of a first direction in the first waveguide, a second path connecting the sending unit to the first waveguide and exciting a polarized wave of a second direction orthogonal to the first direction in the first waveguide, a third path connecting the reception unit to the second waveguide and transmitting a signal by the polarized wave of the first direction sent to the second waveguide, a fourth path connecting the reception unit to the second waveguide and transmitting a signal by the polarized wave of the second direction sent to the second waveguide, a first switch that performs switching between the first path and the second path, and a second switch that performs switching between the third path and the fourth path. The transmission control unit may control the states of the first switch and the second switch.

The communication unit may include a first antenna that performs the transmission of the first signal and a second antenna that performs the transmission of the second signal.

The communication unit may include a sending unit, a reception unit, a first path connecting the sending unit to the first waveguide and exciting a polarized wave of a first direction in the first antenna, a second path connecting the sending unit to the first waveguide and exciting a polarized wave of a second direction orthogonal to the first direction in the first antenna, a third path connecting the reception unit to the second waveguide and transmitting a signal by the polarized wave of the first direction sent to the second antenna, a fourth path connecting the reception unit to the second waveguide and transmitting a signal by the polarized wave of the second direction sent to the second antenna, a first switch that performs switching between the first path and the second path, and a second switch that performs switching between the third path and the fourth path. The transmission control unit may control the states of the first switch and the second switch.

The transmission control unit may set a direction in which the first polarized wave and the second polarized wave are orthogonal to each other.

In a case where a direction of a polarized wave used for the transmission of the first signal and a direction of a polarized wave used for the transmission of the second signal are fixed in the other communication device, the transmission control unit may match the direction of the first polarized wave and the direction of the second polarized wave to the other communication device.

The first signal and the second signal may be signals with a millimeter wave band.

A communication method of a second aspect of the present technology includes: by a communication device that performs transmission of a first signal and a second signal by electromagnetic coupling with another communication device, a setting step of setting a direction of a first polarized wave used for the transmission of the first signal and a direction of a second polarized wave used for the transmission of the second signal in accordance with the other communication device.

An electronic apparatus of a third aspect of the present technology includes: a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and a transmission control unit that sets the direction of the first polarized wave and the direction of the second polarized wave in accordance with the other communication device.

According to the first to third aspects of the present technology, the direction of the first polarized wave used for the transmission of the first signal and the direction of the second polarized wave used for the transmission of the second signal are set in accordance with the other communication device.

### EFFECTS OF THE INVENTION

According to the first to third aspects of the present technology, it is possible to enable a signal to be transmitted regardless of a polarization direction of a communication device which is a communication partner so that interference in a signal can be suppressed.

Note that the effects mentioned here are not necessarily limited and any advantageous effect described in the present specification may be achieved. In addition, the advantageous effects described in the present specification are merely exemplary, the present technology is not limited thereto, and additional advantageous effects may be achieved.

### BRIEF DESCRIPTION OF DRAWINGS

FIG. 1 is a diagram illustrating a configuration example of a communication device according to a first embodiment of the present technology.

FIG. 2 is a diagram illustrating a configuration example of a communication unit of the communication device according to the first embodiment of the present technology.

FIG. 3 is an enlarged diagram illustrating a portion of a waveguide tube of the communication unit in FIG. 2.

FIG. 4 is an explanatory diagram illustrating interference of a signal.

FIG. 5 is an explanatory diagram illustrating a relation of a polarization direction and transmission of a signal between communication devices.

FIG. 6 is an explanatory flowchart illustrating a communication preparation process of a dual role.

FIG. 7 is an explanatory flowchart illustrating a communication preparation process of a host.

FIG. 8 is an explanatory flowchart illustrating a communication preparation process of a device.

FIG. 9 is a diagram illustrating a configuration example of a communication unit of a communication device according to a second embodiment of the present technology.

FIG. 10 is an enlarged diagram illustrating a portion of a waveguide tube of the communication unit in FIG. 9.

FIG. 11 is a diagram illustrating a configuration example of a communication unit of a communication device according to a third embodiment of the present technology.

FIG. 12 is an enlarged diagram illustrating a portion of a waveguide tube of the communication unit in FIG. 11.

### MODE FOR CARRYING OUT THE INVENTION

Hereinafter, modes for carrying out the present technology (hereinafter referred to as “embodiments”) will be described in detail with reference to the drawings. Note that the present technology is not limited to the embodiments and various numerical values, materials, and the like in the embodiments are merely exemplary. In the following description, the same reference numerals are given to the same elements or elements that have the same functions and the repeated description will not be appropriately made. Note that the description will be made in the following order.
1. Overall Description of Present Technology
2. First Embodiment (Example in Which Waveguide Tube Is Used)
3. Second Embodiment (Modification Example of Shape of Waveguide Tube)
4. Third Embodiment (Example in Which Microstrip Antenna Is Used)
5. Modification Examples

### 1. OVERALL DESCRIPTION OF PRESENT TECHNOLOGY

In the present technology, an electromagnetic wave, in particular, a signal with a high frequency such as a microwave, a millimeter wave, or a terahertz wave, can be configured to be used as a signal by which communication is performed between two communication devices. A communication system using a signal with a high frequency is suitable for use of transmission of a signal between various devices, transmission of a signal between circuit substrates in one device (apparatus), or the like.

Note that it is preferable to use a signal with a millimeter wave band among signals with high frequencies as a signal by which communication is performed between two communication devices. A signal with a millimeter wave band is an electromagnetic wave of which a frequency is 30 [GHz] to 300 [GHz] (a wavelength of 1 [mm] to 10 [mm]). By performing signal transmission (communication) in the millimeter wave band, it is possible to realize high-speed signal transmission of a Gbps order (for example, 5 [Gbps] or more). As a signal in which the high-speed signal transmission of a Gbps order is required, for example, a data signal such as a movie video or a computer image can be exemplified. In addition, the signal transmission in the millimeter wave band has an excellent interference resistance property and has an advantage that there is no disturbance to another electric wiring in cable connection between devices.

### 2. FIRST EMBODIMENT

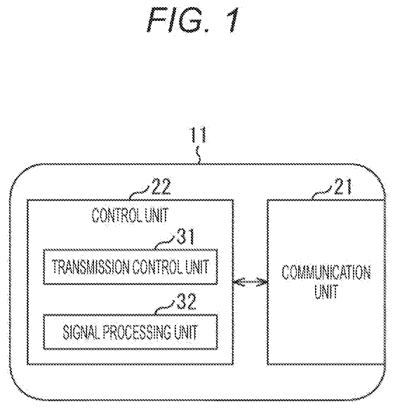

Next, a first embodiment of the present technology will be described with reference to FIGS. 1 to 8.

### <Configuration Example of Communication Device>

FIG. 1 is a block diagram illustrating a configuration example of a communication device to which the present technology is applied. A communication device 11 in FIG. 1 includes a communication unit 21 and a control unit 22.

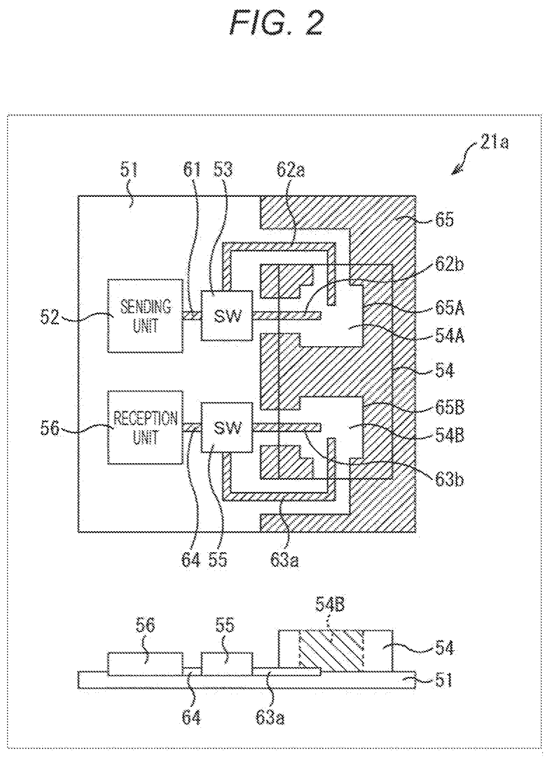

The communication unit 21 performs transmission of a signal by electromagnetic coupling with another communication device under the control of the control unit 22. Note that the details of the configuration of the communication unit 21 will be described later with reference to FIG. 2.

The control unit 22 includes, for example, a processor such as a central processing unit (CPU) and the like. The control unit 22 includes a transmission control unit 31 and a signal processing unit 32.

The transmission control unit 31 controls transmission of a signal through the communication unit 21. For example, the transmission control unit 31 sets a direction of a polarized wave used for sending of a signal and a direction of a polarized wave used for reception in accordance with another communication device performing transmission of a signal with the communication device 11.

The signal processing unit 32 performs various kinds of signal processing. For example, the signal processing unit 32 acquires a signal received from the other communication device from the communication unit 21 and performs various processes on the basis of the acquired signal.

FIG. 2 is a plan view and a front view schematically illustrating a configuration example of a communication unit 21a which is a first embodiment of the communication unit 21 of the communication device 11. Note that a positional relation between units of the communication unit 21a will be described below on the basis of a vertical direction and a horizontal direction of the plan view.

In the communication unit 21a, a sending unit 52, a switch 53, a connector 54, a switch 55, and a reception unit 56 are mounted on a substrate 51. The connector 54 includes a waveguide 54A and a waveguide 54B. The sending unit 52 and the reception unit 56, and the switch 53 and the switch 55 are disposed to be lined in the vertical direction respectively. The sending unit 52, the switch 53, and the waveguide 54A are disposed to be lined in the horizontal direction. The reception unit 56, the switch 55, and the waveguide 54B are disposed to be lined in the horizontal direction.

The sending unit 52 and the switch 53 are connected by a microstrip line 61. The switch 53 and the waveguide 54A are connected by a microstrip line 62a and a microstrip line 62b. The microstrip line 62a extends in the vertical direction from the outside of the connector 54 to the vicinity of the middle of the waveguide 54A (an opening 65A of a pattern 65). A vertically polarized wave (TE10 mode) is sent (excited) by the microstrip line 62a inside the waveguide 54A. The microstrip line 62b extends in the horizontal direction from the outside of the connector 54 to the vicinity of the middle of the waveguide 54A (the opening 65A of the pattern 65). A horizontally polarized wave (TE01 mode) is sent (excited) by the microstrip line 62b inside the waveguide 54A.

The waveguide 54B and the switch 55 are connected by a microstrip line 63a and a microstrip line 63b. The microstrip line 63a extends in the vertical direction from the outside of the connector 54 to the vicinity of the middle of the waveguide 54B (an opening 65B of the pattern 65). A vertically polarized wave (TE10 mode) is received by the microstrip line 63a inside the waveguide 54B. The microstrip line 63b extends in the horizontal direction from the outside of the connector 54 to the vicinity of the middle of the waveguide 54B. A horizontally polarized wave (TE01 mode) is received by the microstrip line 63b inside the waveguide 54B. The switch 55 and the reception unit 56 are connected by a microstrip line 64.

In the pattern 65 on the substrate 51, the rectangular opening 65A and the rectangular opening 65B are formed in accordance to the shapes of the waveguide 54A and the waveguide 54B. The pattern 65 is connected to a ground.

The sending unit 52 modulates a signal supplied from the control unit 22 via a control line (not illustrated) in accordance with a predetermined scheme. For example, the sending unit 52 converts the signal supplied from the control unit 22 into a transmission signal including an Amplitude Shift Keying (ASK) modulated wave with a millimeter wave band. The sending unit 52 supplies the modulated transmission signal to the switch 53 via the microstrip line 61.

The switch 53 switches a transmission path from the switch 53 to the waveguide 54A to the microstrip line 62a or the microstrip line 62b by a control signal supplied from the transmission control unit 31 via a control line (not illustrated) . Then, the switch 53 supplies the transmission signal supplied from the sending unit 52 to the waveguide 54A via the microstrip line 62a or the microstrip line 62b.

The connector 54 includes, for example, a waveguide tube including a metal such as aluminum. The connector 54 is disposed so that the waveguide 54A and the waveguide 54B are lined in the vertical direction. The waveguide 54A and the waveguide 54B include rectangular holes extending in the direction perpendicular to the substrate 51.

The waveguide 54A and the waveguide 54B are filled with a dielectric substance as necessary. As the dielectric substance, for example, polytetrafluoroethylene, a liquid crystal polymer, a cycloolefin polymer, polyimide, polyetheretherketone, polyphenylene sulfide, a thermosetting resin, an ultraviolet curing resin, or the like is used. Note that each entire waveguide may not necessarily be filled with the dielectric substance, at least apart of each waveguide may be filled with the dielectric substance, and at least a portion of an opening end of each waveguide is preferably filled with the dielectric substance.

The transmission signal supplied from the switch 53 to the waveguide 54A is sent from the communication device 11 via the waveguide 54A. At this time, in a case where the transmission signal is supplied to the waveguide 54A along the path passing the microstrip line 62a, a vertically polarized wave is excited in the waveguide 54A and the transmission signal is sent by using the vertically polarized wave. On the other hand, in a case where the transmission signal is supplied to the waveguide 54A along the path passing the microstrip line 62b, a horizontally polarized wave is excited in the waveguide 54A and the transmission signal is sent by using the horizontally polarized wave. Accordingly, the transmission control unit 31 can change the polarized wave to be used for the transmission signal sent from the communication device 11 to the vertically polarized wave or the horizontally polarized wave by switching the state of the switch 53.

On the other hand, the transmission signal sent from another communication device is transmitted to the switch 55 via the waveguide 54B and the microstrip line 63a or the microstrip line 63b. For example, the transmission signal sent by using the vertically polarized wave is supplied to the switch 55 along the path passing the microstrip line 63a. On the other hand, the transmission signal sent by using the horizontally polarized wave is transmitted to the switch 55 along the path passing the microstrip line 63b.

The switch 55 switches a transmission path from the waveguide 54B to the reception unit 56 between the microstrip line 63a and the microstrip line 63b by a control signal supplied from the transmission control unit 31 via a control line (not illustrated). Accordingly, the transmission control unit 31 can change the transmission signal received by the communication device 11 to the transmission signal transmitted by using the vertically polarized wave or the transmission signal transmitted by using the horizontally polarized wave by switching the state of the switch 55. In addition, the switch 55 supplies the transmission signal supplied via the microstrip line 63a or the microstrip line 63b to the reception unit 56 via the microstrip line 64.

The reception unit 56 demodulates the transmission signal supplied from the switch 55 to a signal before the modulation. For example, the reception unit 56 demodulates the transmission signal including the ASK modulated wave with a millimeter wave band into the signal before the modulation. The reception unit 56 supplies the demodulated signal to the control unit 22 via a control line (not illustrated).

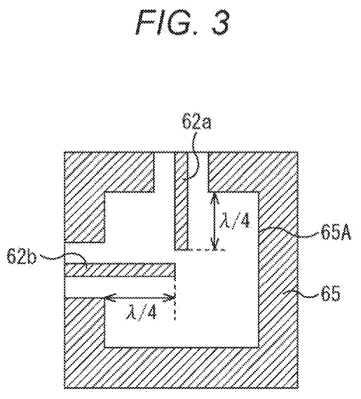

Note that, as illustrated in FIG. 3, lengths of portions of the microstrip line 62a and the microstrip line 62b extending to the inside of the waveguide 54A (the inside of the opening 65A of the pattern 65) are desirably set to ¼ of a wavelength λ of the transmission signal. The same applies to the microstrip line 63a and the microstrip line 63b.

### <Process of Communication Device>

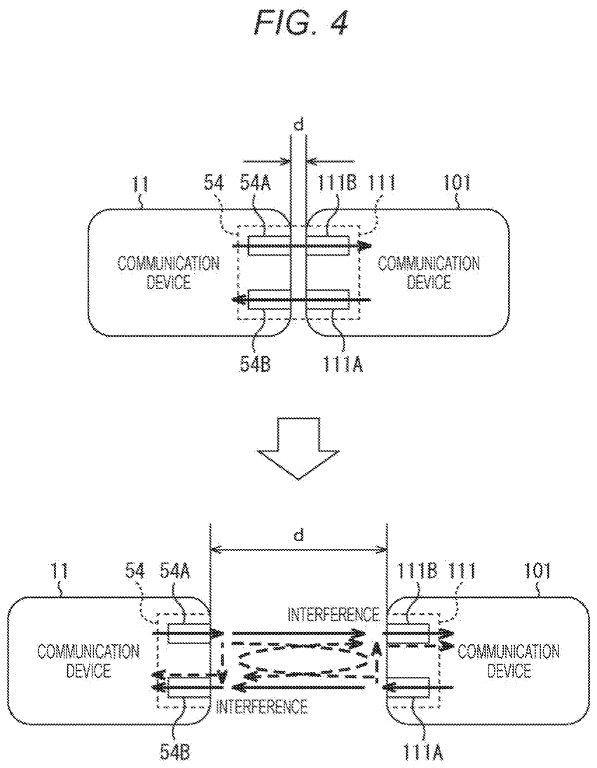

Next, a process of the communication device 11 will be described with reference to FIGS. 4 to 6.

For example, as illustrated in FIG. 4, the casing of the communication device 11 is caused to come into contact with or approach the casing of another communication device 101 and the connector 54 of the communication device 11 is caused to come into contact with or approach a connector 111 of the communication device 101, so that the connector 54 and the connector 111 are electromagnetically coupled. Thus, a signal can be transmitted between the connector 54 and the connector 111.

More specifically, by causing an opening end of the waveguide 54A of the connector 54 to come into contact with or approach an opening end of the waveguide 111B of the connector 111, the waveguide 54A and the waveguide 111B can be electromagnetically coupled so that a signal can be transmitted between the waveguide 54A and the waveguide 111B. Similarly, by causing an opening end of the waveguide 54B of the connector 54 to come into contact with or approach an opening end of the waveguide 111A of the connector 111, the waveguide 54B and the waveguide 111A can be electromagnetically coupled so that a signal can be transmitted between the waveguide 54B and the waveguide 111A.

Here, as a distance (hereinafter referred to as an inter-connector distance) d between the connector 54 and the connector 111 is longer, interference between a transmission signal transmitted from the communication device 11 to the communication device 101 (hereinafter referred to as a transmission signal A) and a transmission signal transmitted from the communication device 101 to the communication device 11 (hereinafter referred to as a transmission signal B) increases.

For example, when the inter-connector distance d is longer, a component increases which leaks from the path between the waveguide 54A and the waveguide 111B or reflects from the casing of the communication device 101 and, for example, returns to the communication device 11 (hereinafter referred to as a leakage component) in the transmission signal A transmitted from the communication device 11 to the communication device 101.

Similarly, when the inter-connector distance d is longer, a leakage component increases which leaks from the path between the waveguide 111A and the waveguide 54B or reflects from the casing of the communication device 11 and, for example, returns to the communication device 101 in the transmission signal B transmitted from the communication device 101 to the communication device 11.

When the leakage component of the transmission signal A increases, a component received by the communication device 101 in the transmission signal A decreases. In addition, a component received via the waveguide 54B by the communication device 11 in the transmission signal A (hereinafter referred to as an interference component) increases.

Similarly, when the leakage component of the transmission signal B increases, a component received by the communication device 11 in the transmission signal B decreases. In addition, an interference component received via the waveguide 111B by the communication device 101 in the transmission signal B increases.

Accordingly, as the inter-connector distance d is longer and the leakage components of the transmission signal A and the transmission signal B increase, a ratio of the transmission signal B which is an interference component to the regular transmission signal A in the transmission signal received by the communication device 101 increases. Similarly, a ratio of the transmission signal A which is an interference component to the regular transmission signal B in the transmission signal received by the communication device 11 increases. As a result, quality of the transmission signal is lowered or the transmission signal cannot be transmitted.

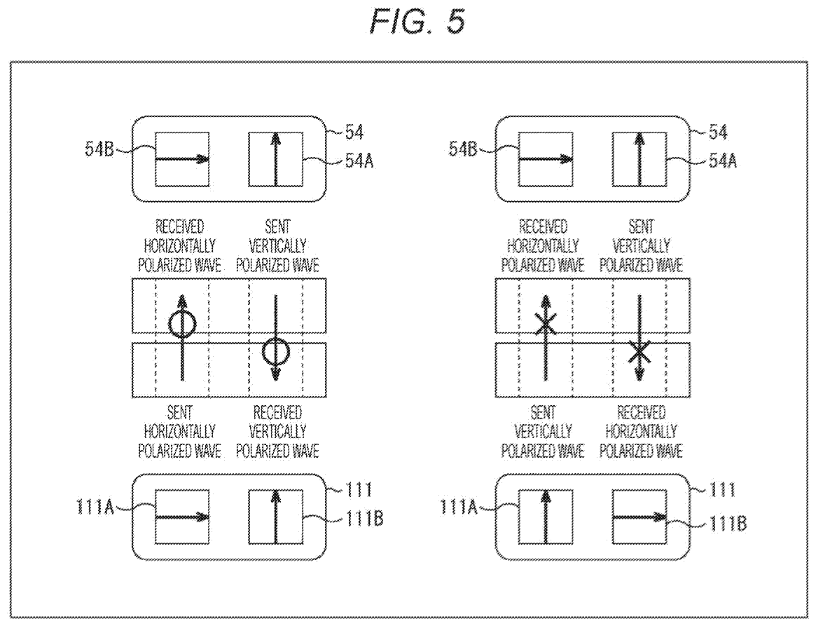

On the other hand, for example, as illustrated in FIG. 5, the interference between the transmission signal A and the transmission signal B is considered to be suppressed by transmitting the transmission signal A sent from the waveguide 54A of the connector 54 of the communication device 11 by using the vertically polarized wave and transmitting the transmission signal B received via the waveguide 54B by using the horizontally polarized wave.

At this time, as illustrated on the left side of FIG. 5, in a case where the waveguide 111A of the connector 111 of the communication device 101 can send the transmission signal by the horizontally polarized wave and the waveguide 111B can receive the transmission signal by the vertically polarized wave, a direction of a sendable polarized wave and a direction of a receivable polarized wave match between the communication device 11 and the communication device 101. As a result, signals in both directions can be transmitted in parallel while suppressing the interference between the communication device 11 and the communication device 101.

However, as illustrated on the right side of FIG. 5, in a case where the waveguide 111A of the connector 111 of the communication device 101 can send the transmission signal by the vertically polarized wave and the waveguide 111B can receive the transmission signal by the horizontally polarized wave, the direction of the sendable polarized wave and the direction of the receivable polarized wave do not match between the communication device 11 and the communication device 101. As a result, a signal cannot be transmitted between the communication device 11 and the communication device 101.

On the other hand, the communication device 11 enables transmission of the signal regardless of the polarization direction of the communication device 101 by switching the direction of the polarized wave used for sending of the transmission signal and the direction of the polarized wave used for reception of the transmission signal, so that the interference of the signals can be suppressed.

Note that, hereinafter, communication devices or electronic apparatuses including communication devices are assumed to be classified into three types of host, device, and dual role. For example, a personal computer or the like serves as a host. For example, a monitor, a storage, a printer, a keyboard, a mouse, or the like serves as a device. For example, a smartphone, a digital camera, or the like serves as a dual role.

In addition, hereinafter, for a host and a device, a direction of a polarized wave used for sending and reception is assumed to be fixed. Specifically, a host is assumed to use a vertically polarized wave for sending and a horizontally polarized wave for reception, and a device is assumed to use a horizontally polarized wave for sending and a vertically polarized wave for reception. On the other hand, for a dual role, a direction of a polarized wave used for sending or reception is variable and the dual role can be used as either a host or a device. The communication device 11 is a dual role.

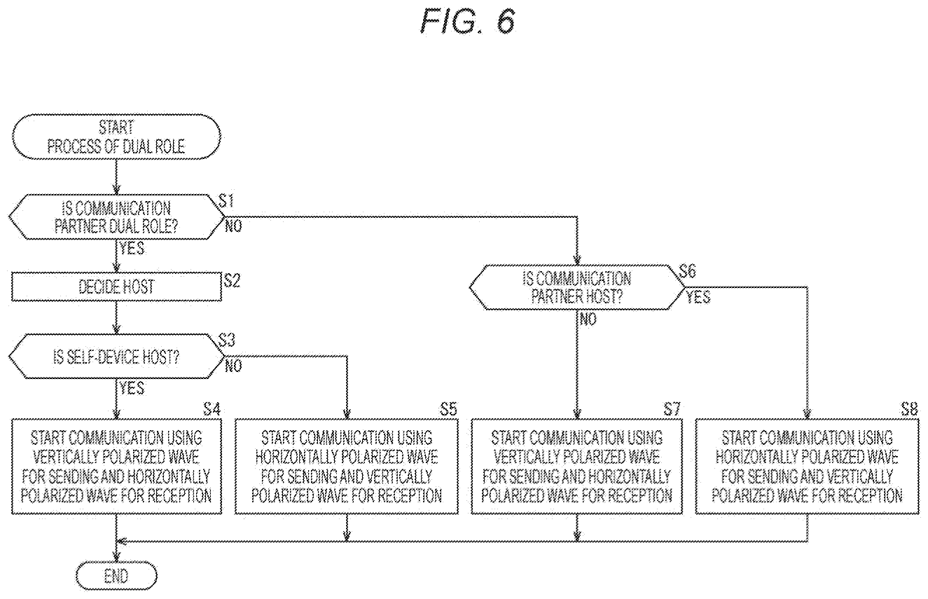

Next, a communication preparation process performed by the communication device 11 will be described with reference to the flowchart of FIG. 6. This process starts, for example, when the communication device 11 starts communication with the communication device 101.

In step S1, the transmission control unit 31 determines whether or not a communication partner (the communication device 101) is a dual role. For example, the transmission control unit 31 sends an inquiry signal for inquiring about a type of communication device 101 via the sending unit 52, the switch 53, and the waveguide 54A. In addition, the transmission control unit 31 receives a response signal to the inquiry signal from the communication device 101 via the waveguide 54B, the switch 55, and the reception unit 56.

At this time, the transmission control unit 31 controls the states of the switch 53 and the switch 55 such that the inquiry signal can be sent and the response signal can be received, regardless of the type of communication device 101, and switches the direction of the polarized wave used for the sending of the inquiry signal and the direction of the polarized wave used for reception of the response signal.

Then, in a case where the transmission control unit 31 determines that the communication partner is the dual role on the basis of the received response signal, the process proceeds to step S2.

In step S2, the transmission control unit 31 decides a host. Specifically, the transmission control unit 31 communicates with the communication device 101 via the sending unit 52, the switch 53, the waveguide 54A, the waveguide 54B, the switch 55, and the reception unit 56 and decides which serves as the host between the communication device 11 and the communication device 101. Note that any method can be adopted as a method of deciding the host.

In step S3, the transmission control unit 31 determines whether or not the self-device is a host on the basis of a result of the process of step S2. In a case where it is determined that the self-device is the host, the process proceeds to step S4.

In step S4, the communication device 11 starts communication using the vertically polarized wave for the sending and the horizontally polarized wave for the reception. Specifically, the transmission control unit 31 controls the switch 53 such that the sending unit 52 and the waveguide 54A are set to a state connected via the microstrip line 62a. In addition, the transmission control unit 31 controls the switch 55 such that the waveguide 54B and the reception unit 56 are set to a state connected via the microstrip line 63b. Thus, the communication device 11 serves as a host, performs sending by using the vertically polarized wave, and performs reception by using the horizontally polarized wave. Then, the sending unit 52 and the reception unit 56 start communication with the communication device 101 under the control of the transmission control unit 31.

Thereafter, the communication preparation process ends.

Conversely, in a case where it is determined in step S3 that the self-device is the device, the process proceeds to step S5.

In step S4, the communication device 11 starts communication using the horizontally polarized wave for the sending and the vertically polarized wave for the reception. Specifically, the transmission control unit 31 controls the switch 53 such that the sending unit 52 and the waveguide 54A are set to a state connected via the microstrip line 62b. In addition, the transmission control unit 31 controls the switch 55 such that the waveguide 54B and the reception unit 56 are set to a state connected via the microstrip line 63a. Thus, the communication device 11 serves as a device, performs sending by using the horizontally polarized wave, and performs reception by using the vertically polarized wave. Then, the sending unit 52 and the reception unit 56 start communication with the communication device 101 under the control of the transmission control unit 31.

Thereafter, the communication preparation process ends.

Conversely, in a case where it is determined in step S1 that the communication partner is not the dual role, the process proceeds to step S6.

In step S6, the transmission control unit 31 determines whether or not the communication partner is a host on the basis of the response signal received from the communication device 101. In a case where it is determined that the communication partner is not the host but the device, the process proceeds to step S7.

In step S7, the communication starts using the vertically polarized wave for the sending and the horizontally polarized wave for the reception as in the process of step S4. That is, the communication device 11 serves as the host and performs communication with the communication device 101.

Thereafter, the communication preparation process ends.

Conversely, in a case where it is determined in step S6 that the communication partner is the host, the process proceeds to step S8.

In step S8, the communication starts using the horizontally polarized wave for the sending and the vertically polarized wave for the reception as in the process of step S5. That is, the communication device 11 serves as the device and performs communication with the communication device 101.

Thereafter, the communication preparation process ends.

In this way, the communication device 11 can switch between the directions of the polarized waves used for the sending and the reception in accordance with the type of communication device 101. Thus, the communication device 11 can communicate with the communication device 101 regardless of the type of communication device 101. Accordingly, for example, it is not necessary to prepare for two types of communication devices 101 of the host and the device.

In addition, since the polarized wave used for the sending and the polarized wave used for the reception are orthogonal to each other, the occurrence of the interference between the sent signal and the received signal is suppressed in the communication device 11 and the communication device 101.

### <Process in Case Where Host Takes Lead>

Note that in FIG. 6, the communication device 11 serving as the dual role takes lead, detects the type of communication device 101 serving as the communication partner, and sets whether the self-device is the host or the device in accordance with the type of communication device 101. In addition, in a case where the communication device 101 is the dual role, the communication device 11 and the communication device 101 decide which serves as the host or the device between both devices.

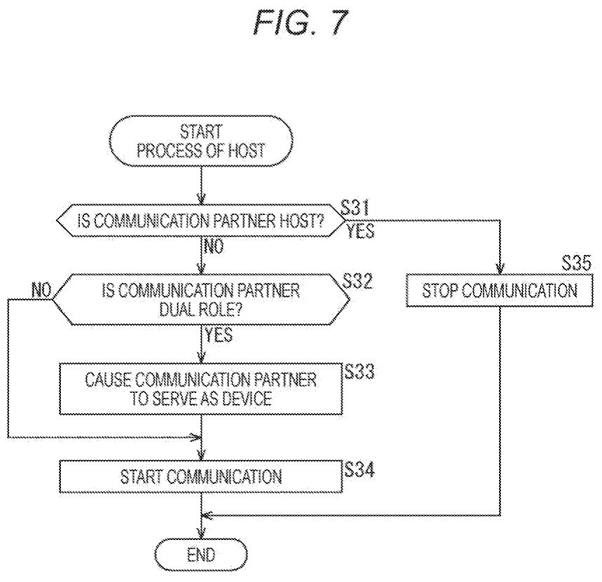

Here, for reference, a process in a case where the host takes lead, detects the type of communication partner, and sets the type of communication partner in a case where the communication partner is a dual role will be described with reference to the flowchart of FIG. 7.

In step S31, the host determines whether or not the communication partner is a host. Specifically, the host sends an inquiry signal to the communication partner as in the process of step S1 of FIG. 6. Then, in a case where the response signal is received from the communication partner, the host determines that the communication partner is not the host and the process proceeds to step S32.

In step S32, the host determines whether or not the communication partner is a dual role on the basis of the received response signal. In a case where it is determined that the communication partner is the dual role, the process proceeds to step S33.

In step S33, the host causes the communication partner to serve as a device. For example, the host sends a setting request signal for making a request for setting the communication partner as the device to the communication partner.

In response thereto, the communication partner sets the self-device as the device. For example, in a case where the communication partner is the communication device 11, when the setting request signal is received from the host, the transmission control unit 31 of the communication device 11 controls the switch 53 and sets the sending unit 52 and the waveguide 54A to a state connected via the microstrip line 62b. In addition, the transmission control unit 31 controls the switch 55 and sets the waveguide 54B and the reception unit 56 to a state connected via the microstrip line 63a. Thus, for the communication device 11, the horizontally polarized wave is set for the sending and the vertically polarized wave is set for the reception.

Thereafter, the process proceeds to step S34.

Conversely, in a case where it is determined in step S32 that the communication partner is the device, the process of step S33 is skipped and the process proceeds to step S34.

In step S34, the host starts communication. At this time, the host performs sending by using the vertically polarized wave and performs reception by using the horizontally polarized wave.

Thereafter, the communication preparation process ends.

Conversely, in a case where the response signal cannot be received from the communication partner in step S31, the host determines that the communication partner is the host and the process proceeds to step S35. That is, in a case where the communication partner is the host, both communication devices perform the sending by using the vertically polarized wave and perform reception by using the horizontally polarized wave. Therefore, a signal may not be received. Accordingly, in a case where a response signal may not be received from the communication partner, the host determines that the communication partner is the host and the process proceeds to step S35.

In step S35, the host stops the communication.

Thereafter, the communication preparation process ends.

### <Process in Case Where Device Takes Lead>

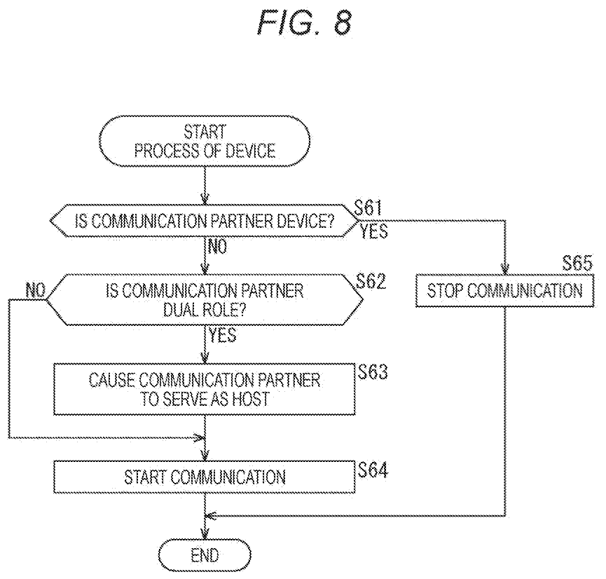

Here, for reference, a process in a case where the device takes lead, detects the type of communication partner, and sets the type of communication partner in a case where the communication partner is a dual role will be described with reference to the flowchart of FIG. 8.

In step S61, the device determines whether or not the communication partner is a device. Specifically, the device sends an inquiry signal to the communication partner as in the process of step S1 of FIG. 6. Then, in a case where the response signal is received from the communication partner, the device determines that the communication partner is not the device and the process proceeds to step S62.

In step S62, the device determines whether or not the communication partner is a dual role on the basis of the received response signal . Ina case where it is determined that the communication partner is the dual role, the process proceeds to step S63.

In step S63, the device causes the communication partner to serve as a host. For example, the device sends a setting request signal for making a request for setting the communication partner as the host to the communication partner.

In response thereto, the communication partner sets the self-device as the host . For example, in a case where the communication partner is the communication device 11, when the setting request signal is received from the device, the transmission control unit 31 of the communication device 11 controls the switch 53 and sets the sending unit 52 and the waveguide 54A to a state connected via the microstrip line 62a. In addition, the transmission control unit 31 controls the switch 55 and sets the waveguide 54B and the reception unit 56 to a state connected via the microstrip line 63b. Thus, for the communication device 11, the vertically polarized wave is set for the sending and the horizontally polarized wave is set for the reception.

Thereafter, the process proceeds to step S64.

Conversely, in a case where it is determined in step S62 that the communication partner is the host, the process of step S63 is skipped and the process proceeds to step S64.

In step S64, the device starts communication. At this time, the device performs sending by using the horizontally polarized wave and performs reception by using the vertically polarized wave.

Thereafter, the communication preparation process ends.

Conversely, in a case where the response signal may not be received from the communication partner in step S61, the device determines that the communication partner is the device and the process proceeds to step S65. That is, in a case where the communication partner is the host, both communication devices perform the sending by using the horizontally polarized wave and perform reception by using the vertically polarized wave. Therefore, a signal cannot be received. Accordingly, in a case where a response signal may not be received from the communication partner, the device determines that the communication partner is the device and the process proceeds to step S65.

In step S65, the device stops the communication.

Thereafter, the communication preparation process ends.

### 3. SECOND EMBODIMENT

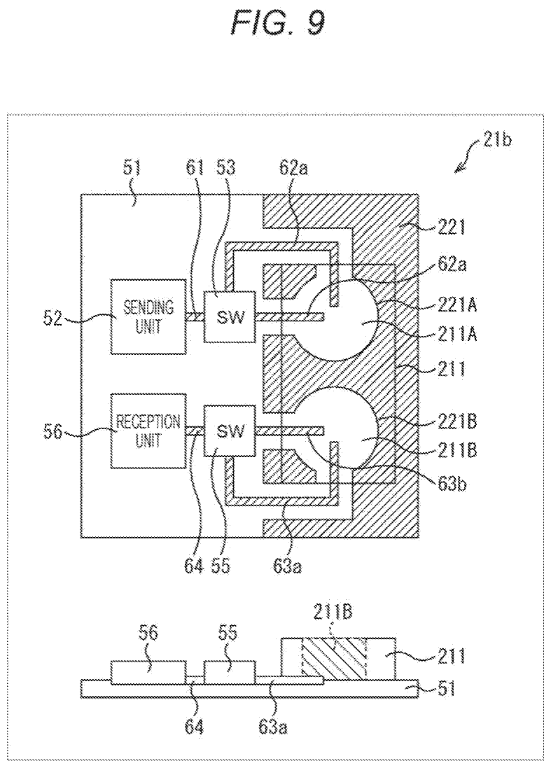

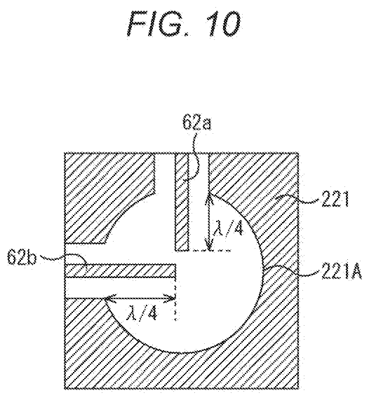

Next, a second embodiment of the present technology will be described with reference to FIGS. 9 and 10.

In the second embodiment, a communication unit 21b in FIG. 9 is used in the communication device 11 instead of the communication unit 21a in FIG. 2. Note that in FIGS. 9 and 10, the same reference numerals are given to portions corresponding to FIGS. 2 and 3 and the description will not be appropriately repeated.

The communication unit 21b is different from the communication unit 21a in that a connector 211 is provided instead of the connector 54 and a pattern 221 is provided on the substrate 51 instead of the pattern 65.

The connector 211 includes a waveguide tube as in the connector 54, but the shapes of a waveguide 211A and a waveguide 211B are different. That is, the waveguide 211A and the waveguide 211B include circular holes extending in the direction perpendicular to the substrate 51.

Note that the waveguide 211A and the waveguide 211B are filled with a dielectric substance as necessary, as in the waveguide 54A and the waveguide 54B of the connector 54.

In the pattern 221, a circular opening 221A and a circular opening 221B are formed to be suitable for the shapes of the waveguide 211A and the waveguide 211B. The pattern 221 is connected to a ground.

Note that, as illustrated in FIG. 10, lengths of portions of the microstrip line 62a and the microstrip line 62b extending to the inside of the waveguide 211A (the inside of the opening 221A of the pattern 221) are preferably set to ¼ of a wavelength λ of the transmission signal. The same applies to the microstrip line 63a and the microstrip line 63b.

In this way, the waveguide 211A and the waveguide 211B can also be circular.

In addition, by setting the waveguide 211A and the waveguide 211B to be circular, for example, it is also possible to perform the transmission of a signal while switching the polarized waves used for the sending and the reception in accordance with the communication partner using a left hand circularly polarized wave and a right hand circularly polarized wave orthogonal to each other instead of the vertically polarized wave and the horizontally polarized wave.

### 4. THIRD EMBODIMENT

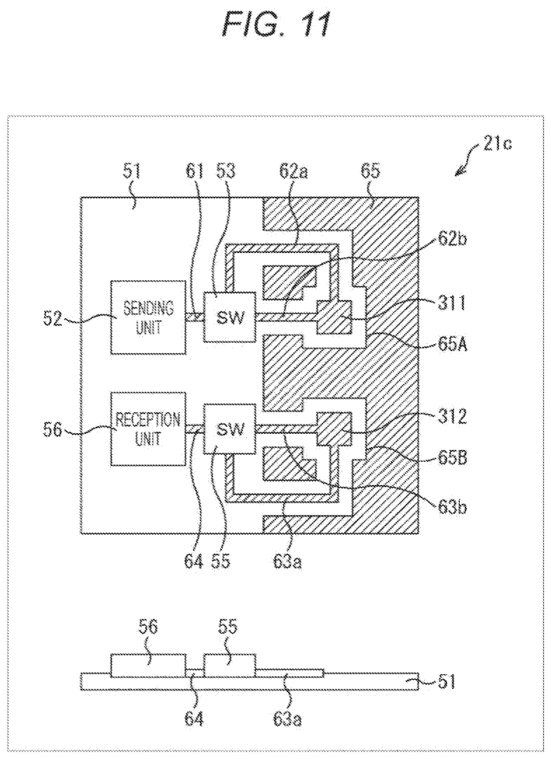

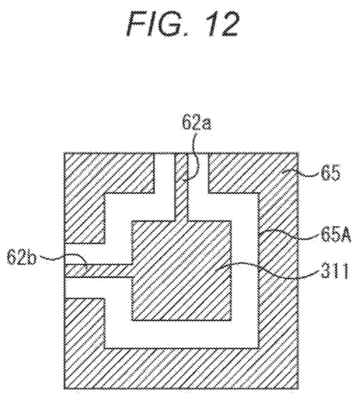

Next, a third embodiment of the present technology will be described with reference to FIGS. 11 and 12.

In the third embodiment, a communication unit 21c in FIG. 11 is used in the communication device 11 instead of the communication unit 21a in FIG. 2. Note that in FIGS. 11 and 12, the same reference numerals are given to portions corresponding to FIGS. 2 and 3 and the description will not be appropriately repeated.

The communication unit 21c is different from the communication unit 21a in that the connector 54 is removed and a microstrip antenna 311 and a microstrip antenna 312 are provided.

The microstrip antenna 311 is formed as a rectangular pattern inside the opening 65A of the pattern 65 of the substrate 51. The microstrip antenna 311 is connected to the switch 53 via the microstrip line 62a and the microstrip line 62b.

Accordingly, the microstrip antenna 311 can switch the polarized wave used for the sending to the vertically polarized wave or the horizontally polarized wave in accordance with the state of the switch 53 as in the waveguide 54A of the connector 54 of the communication unit 21a.

The microstrip antenna 312 is formed as a rectangular pattern inside the opening 65B of the pattern 65 of the substrate 51. The microstrip antenna 312 is connected to the switch 55 via the microstrip line 63a and the microstrip line 63b.

Accordingly, the microstrip antenna 311 can switch the polarized wave used for the reception to the vertically polarized wave or the horizontally polarized wave in accordance with the state of the switch 55 as in the waveguide 54B of the connector 54 of the communication unit 21a.

### 5. MODIFICATION EXAMPLES

The preferred embodiments of the present technology have been described above, but the present technology is not limited to the foregoing embodiments and various alternations and improvements of the foregoing embodiments can be achieved within the scope of the gist of the present technology.

For example, the present technology can be applied to a communication device performing transmission of signals of three or more channels using polarized waves with different directions and an electronic apparatus including the communication device.

In addition, for example, the present technology can be applied to a communication device performing transmission in a single direction (only sending or only reception) of signals of two or more channels using polarized waves with different directions and an electronic apparatus including the communication device.

Further, methods of transmitting signals by electromagnetic coupling using polarized waves is not limited to the above-described methods and other methods can also be adopted.

In addition, methods of detecting types of communication partners are not limited to the above-described examples, but any method can be adopted.

Further, for example, some or all of the functions of the control unit 22 may be provided in the communication unit 21. For example, the transmission control unit 31 may be provided in the communication unit 21 and control of the switch 53 and the switch 55 may be performed in the communication unit 21.

In addition, the above-described series of processes may be performed by hardware or may be performed by software.

Note that in a case where the series of processes is performed by software, a program which is executed by a computer may be a program that chronologically performs the processes in the procedure described in the present specification or may be a program that performs the processes at necessary timings in parallel, when called, or the like.

In addition, in the present specification, the system means a set of a plurality of constituent elements (devices, modules (components), or the like) and all the constituent elements are not necessarily in the same casing. Accordingly, a plurality of devices accommodated in separate casings and connected via a network and one device in which a plurality of modules is accommodated in one casing are all the system.

Further, embodiments of the present technology are not limited to the above-described embodiments and can be modified in various forms within the scope of the present technology without departing from the gist of the present technology.

For example, the present technology can have a configuration of cloud computing in which one function is distributed to a plurality of devices via a network to be processed in cooperation.

In addition, the steps described in the above-described flowcharts can be performed by one device or can be distributed and performed by a plurality of devices.

Further, in a case where a plurality of processes is included in one step, the plurality of processes included in the one step can be performed by one device and can also be distributed and performed by a plurality of devices.

In addition, the effects described in the present specification are merely exemplary and are not limited, and other advantageous effects may be achieved.

Further, for example, the present technology can also have the following configurations.

(1)

A communication device including:

a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and

a transmission control unit that sets the direction of the first polarized wave and the direction of the second polarized wave in accordance with the other communication device.

(2)

The communication device according to (1), in which the communication unit includes

a first waveguide that performs the transmission of the first signal, and

a second waveguide that performs the transmission of the second signal.

(3)

The communication device according to (2),

in which the communication unit includes
a sending unit,
a reception unit,
a first path connecting the sending unit to the first waveguide and exciting a polarized wave of a first direction in the first waveguide,
a second path connecting the sending unit to the first waveguide and exciting a polarized wave of a second direction orthogonal to the first direction in the first waveguide,
a third path connecting the reception unit to the second waveguide and transmitting a signal by the polarized wave of the first direction sent to the second waveguide,
a fourth path connecting the reception unit to the second waveguide and transmitting a signal by the polarized wave of the second direction sent to the second waveguide,
a first switch that performs switching between the first path and the second path, and
a second switch that performs switching between the third path and the fourth path, and

the transmission control unit controls states of the first switch and the second switch.

(4)

The communication device according to (1), in which the communication unit includes

a first antenna that performs the transmission of the first signal, and

a second antenna that performs the transmission of the second signal.

(5)

The communication device according to (4),

in which the communication unit includes
a sending unit,
a reception unit,
a first path connecting the sending unit to the first waveguide and exciting a polarized wave of a first direction in the first antenna,
a second path connecting the sending unit to the first waveguide and exciting a polarized wave of a second direction orthogonal to the first direction in the first antenna,
a third path connecting the reception unit to the second waveguide and transmitting a signal by the polarized wave of the first direction sent to the second antenna,
a fourth path connecting the reception unit to the second waveguide and transmitting a signal by the polarized wave of the second direction sent to the second antenna,
a first switch that performs switching between the first path and the second path, and
a second switch that performs switching between the third path and the fourth path, and

the transmission control unit controls states of the first switch and the second switch.

(6)

The communication device according to any of (1) to (5), in which the transmission control unit sets a direction in which the first polarized wave and the second polarized wave are orthogonal to each other.

(7)

The communication device according to any of (1) to (6), in which in a case where a direction of a polarized wave used for the transmission of the first signal and a direction of a polarized wave used for the transmission of the second signal are fixed in the other communication device, the transmission control unit matches the direction of the first polarized wave and the direction of the second polarized wave to the other communication device.

(8)

The communication device according to any of (1) to (7), in which the first signal and the second signal are signals with a millimeter wave band.

(9)

A communication method including: by a communication device that performs transmission of a first signal and a second signal by electromagnetic coupling with another communication device,

a setting step of setting a direction of a first polarized wave used for the transmission of the first signal and a direction of a second polarized wave used for the transmission of the second signal in accordance with the other communication device.

(10)

An electronic apparatus including:

a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and

a transmission control unit that sets the direction of the first polarized wave and the direction of the second polarized wave in accordance with the other communication device.

### REFERENCE SIGNS LIST

11 Communication device
21, 21a to 21c Communication unit
22 Control unit
31 Transmission control unit
32 Signal processing unit
52 Sending unit
53 Switch
54 Connector
54A, 54B Waveguide
55 Switch
56 Reception unit
62a to 63b Microstrip line
211 Connector
211A, 211B Waveguide
311, 312 Microstrip antenna

1. A communication device comprising:
a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and
a transmission control unit that sets the direction of the first polarized wave and the direction of the second polarized wave in accordance with the other communication device.

2. The communication device according to claim 1, wherein the communication unit includes
a first waveguide that performs the transmission of the first signal, and
a second waveguide that performs the transmission of the second signal.

3. The communication device according to claim 2,
wherein the communication unit includes
a sending unit,
a reception unit,
a first path connecting the sending unit to the first waveguide and exciting a polarized wave of a first direction in the first waveguide,
a second path connecting the sending unit to the first waveguide and exciting a polarized wave of a second direction orthogonal to the first direction in the first waveguide,
a third path connecting the reception unit to the second waveguide and transmitting a signal by the polarized wave of the first direction sent to the second waveguide,
a fourth path connecting the reception unit to the second waveguide and transmitting a signal by the polarized wave of the second direction sent to the second waveguide,
a first switch that performs switching between the first path and the second path, and
a second switch that performs switching between the third path and the fourth path, and
the transmission control unit controls states of the first switch and the second switch.

4. The communication device according to claim 1, wherein the communication unit includes
a first antenna that performs the transmission of the first signal, and
a second antenna that performs the transmission of the second signal.

5. The communication device according to claim 4,
wherein the communication unit includes
a sending unit,
a reception unit,
a first path connecting the sending unit to the first waveguide and exciting a polarized wave of a first direction in the first antenna,
a second path connecting the sending unit to the first waveguide and exciting a polarized wave of a second direction orthogonal to the first direction in the first antenna,
a third path connecting the reception unit to the second waveguide and transmitting a signal by the polarized wave of the first direction sent to the second antenna,
a fourth path connecting the reception unit to the second waveguide and transmitting a signal by the polarized wave of the second direction sent to the second antenna,
a first switch that performs switching between the first path and the second path, and
a second switch that performs switching between the third path and the fourth path, and
the transmission control unit controls states of the first switch and the second switch.

6. The communication device according to claim 1, wherein the transmission control unit sets a direction in which the first polarized wave and the second polarized wave are orthogonal to each other.

7. The communication device according to claim 1, wherein in a case where a direction of a polarized wave used for the transmission of the first signal and a direction of a polarized wave used for the transmission of the second signal are fixed in the other communication device, the transmission control unit matches the direction of the first polarized wave and the direction of the second polarized wave to the other communication device.

8. The communication device according to claim 1, wherein the first signal and the second signal are signals with a millimeter wave band.

9. A communication method comprising: by a communication device that performs transmission of a first signal and a second signal by electromagnetic coupling with another communication device,
a setting step of setting a direction of a first polarized wave used for the transmission of the first signal and a direction of a second polarized wave used for the transmission of the second signal in accordance with the other communication device.

10. An electronic apparatus comprising:
a communication unit that performs transmission of a first signal and a second signal by electromagnetic coupling with another communication device and is able to change each of a direction of a first polarized wave used for the transmission of the first signal and a direction of a second polarized wave used for the transmission of the second signal; and
a transmission control unit that sets the direction of the first polarized wave and the direction of the second polarized wave in accordance with the other communication device.
